(19) United States
(12) Patent Application Publication
(10) Pub. No.: US 2025/0350986 A1
(43) Pub. Date: Nov. 13, 2025

(54) MEASUREMENT REPORTING ON A CHANGE OF REPORTED NEIGHBORING CELLS

(71) Applicant: Nokia Technologies Oy, Espoo (FI)

(72) Inventors: Halit Murat GÜRSU, Munich (DE); Behnam KHODAPANAH, Munich (DE); Jedrzej STANCZAK, Wroclaw (PL); Jean-Michel PUGEAT, Massy (FR)

(21) Appl. No.: 19/194,309

(22) Filed: Apr. 30, 2025

(30) Foreign Application Priority Data
May 10, 2024 (GB) 2406593.0

(51) Int. Cl. H04W 24/10; H04B 17/318; H04W 24/08

(52) U.S. Cl. CPC H04W 24/10; H04B 17/318; H04W 24/08

(57) ABSTRACT

A method is provided that includes performing measurements on neighboring cells to obtain second measurement quantities for the neighboring cells. The method includes determining a change of reported ones of the neighboring cells from a first measurement reporting, based on a comparison of the second measurement quantities and first measurement quantities for at least the reported ones of the neighboring cells during the first measurement reporting. Determining the change triggers a second measurement reporting, and the method includes initiating the second measurement reporting of at least some of the second measurement quantities based on the triggering. A corresponding apparatus comprising means for performing the method is also provided.

### TECHNOLOGICAL FIELD

The present disclosure relates generally to telecommunications and, in particular, to neighboring cell measurement reporting.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless telecommunications systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how operations should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF SUMMARY

Example implementations of the present disclosure are directed to telecommunications and, in particular, to neighboring cell measurement reporting. The present disclosure includes, without limitation, the following example implementations.

Some example implementations provide an apparatus comprising: at least one memory configured to store instructions; and at least one processing circuitry configured to access the at least one memory, and execute the instructions to cause the apparatus to at least: perform measurements on neighboring cells to obtain second measurement quantities for the neighboring cells; determine a change of reported ones of the neighboring cells from a first measurement reporting, based on a comparison of the second measurement quantities and first measurement quantities for at least the reported ones of the neighboring cells during the first measurement reporting, determination of the change triggering a second measurement reporting; and initiate the second measurement reporting of at least some of the second measurement quantities based on the triggering.

Some example implementations provide an apparatus comprising: means for performing measurements on neighboring cells to obtain second measurement quantities for the neighboring cells; means for determining a change of reported ones of the neighboring cells from a first measurement reporting, based on a comparison of the second measurement quantities and first measurement quantities for at least the reported ones of the neighboring cells during the first measurement reporting, determining the change triggering a second measurement reporting; and means for initiating the second measurement reporting of at least some of the second measurement quantities based on the triggering.

Some example implementations provide a method comprising: performing measurements on neighboring cells to obtain second measurement quantities for the neighboring cells; determining a change of reported ones of the neighboring cells from a first measurement reporting, based on a comparison of the second measurement quantities and first measurement quantities for at least the reported ones of the neighboring cells during the first measurement reporting, determining the change triggering a second measurement reporting; and initiating the second measurement reporting of at least some of the second measurement quantities based on the triggering.

Some example implementations provide a computer-readable storage medium that is non-transitory and has instructions stored therein that, in response to execution by at least one processing circuitry, causes an apparatus to at least: perform measurements on neighboring cells to obtain second measurement quantities for the neighboring cells; determine a change of reported ones of the neighboring cells from a first measurement reporting, based on a comparison of the second measurement quantities and first measurement quantities for at least the reported ones of the neighboring cells during the first measurement reporting, determination of the change triggering a second measurement reporting; and initiate the second measurement reporting of at least some of the second measurement quantities based on the triggering.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a deployment of a PLMN, according to some example implementations;

FIG. 3 illustrates a measurement reporting scenario in which a cell that triggers a reporting event A4 is not reported;

FIG. 4 is a flow diagram for a user equipment to track the order of reported neighboring cells, according to some example implementations;

FIG. 5 illustrates a measurement reporting scenario according to some example implementations;

FIG. 6 illustrates a measurement reporting scenario including a configured threshold value and threshold time period, according to some example implementations;

FIG. 7 illustrates another measurement reporting scenario including a configured threshold value and threshold time period, according to some other example implementations;

FIGS. 8A, 8B, 8C, 8D, 8E, 8F and 8G are flowcharts illustrating various steps in a method according to various example implementations; and

FIG. 9 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced, 5G NR, 5G Advanced and 6G; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

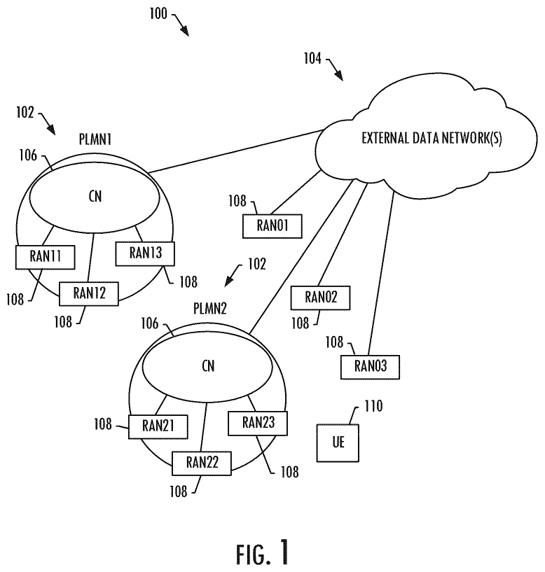

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104—notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunications network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIoT device), a vehicle equipped with a vehicle-to-everything (V2X) communication technology, or the like. In some examples, as referenced by 3GPP, the UE may be a narrowband IoT (NB-IoT) device, an enhanced machine-type communication (eMTC) device, a reduced capability (RedCap) device, an ambient IoT device, or the like.

In operation, these UEs 110 may be configured to connect to one or more of the RANs 108 according to their particular radio access technologies to thereby access a particular CN 106 of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIoT).

Examples of radio access technologies include 3GPP radio access technologies such as GSM, UMTS, LTE, LTE Advanced, 5G NR, 5G Advanced, and 6G. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G, 6G or higher generation mobile communication technology and their different versions, as well as to any other wireless radio access technology that may be arranged to interwork with such a mobile communication technology to provide access to the CN 106 of a mobile network operator (MNO).

In various examples, a RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), enhanced gNB (en-gNB), next generation eNB (ng-eNB), or the like. The RAN may include some type of network controlling/governing entity responsible for control of the radio access nodes. The network controlling/governing entity and radio access node may be separate or integrated into a single apparatus. The network controlling/governing entity may include processing circuity configured to carry out various management functions, etc. The processing circuity may be associated with a memory, computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

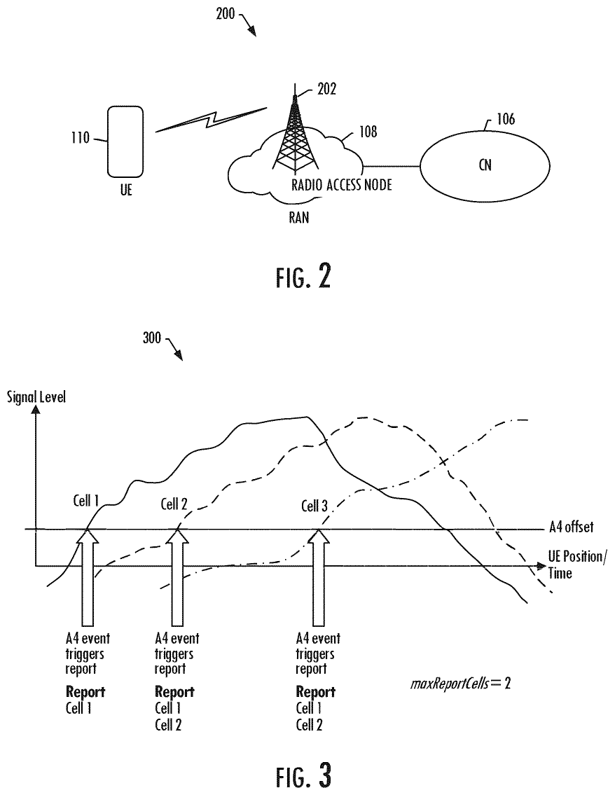

As will be appreciated, a PLMN 102 may be deployed in a number of different manners. FIG. 2 illustrates a deployment 200 of a PLMN, such as a 4G LTE, 5G or 6G deployment, according to some example implementations. As shown, the deployment includes a CN 106, and RAN 108 with one or more radio access nodes 202 configured to interact with UEs 110. In a 4G LTE deployment, the EPC is the CN, and the evolved UMTS terrestrial radio access network (E-UTRAN) is the RAN; and the E-UTRAN includes one or more eNBs (radio access nodes) configured to connect UEs to the E-UTRAN to thereby access the EPC. Similarly, in a 5G deployment, the 5GC is the CN 106, and the next generation (NG) radio access network (NG-RAN) is the RAN 108; and the NG-RAN includes one or more gNBs (radio access nodes) configured to connect UEs 110 to the NG-RAN to thereby access the 5GC (at times referred to as the NGC). The term ‘gNB’ in 5G may correspond to the eNB in 4G LTE.

Some deployments of 4G LTE and 5G in particular are considered standalone (SA) deployments. Other deployments combine 4G LTE and 5G technologies, and are referred to as non-standalone (NSA) deployments. In some deployments, the E-UTRAN includes one or more ng-eNBs that are configured to communicate with the 5GC, and that may also be configured to communicate with one or more gNBs. Similarly, in another deployment, the NG-RAN may include one or more en-gNBs that are configured to communicate with the EPC, and that may also be configured to communicate with one or more eNBs. In various instances, a single UE 110, a dual-mode or multimode UE, may support multiple (two or more) RANs—thereby being configured to connect to multiple RANs, such as 4G LTE and 5G.

In various instances, a single UE 110, a dual-mode or multimode UE, may support carrier aggregation (CA), dual-connectivity (DC) or multi-connectivity (MC). In this regard, CA allows the UE to simultaneously connect to cells on multiple carriers, enabling the UE to reach higher throughputs, as well as fast-time-scale load-balancing across multiple carriers. A UE will generally have a primary cell, known as a PCell, which is typically the cell through which the UE first connects to the RAN 108. The RAN (typically via the PCell) may provide the UE additional configuration information to enable it to simultaneously connect to additional cells on carriers other than the PCell, which are known as the UE's secondary cells or SCells.

The PCell radio access node may be referred to as a master node (MN), and the SCell radio access node may be referred to as a secondary node (SN). Relatedly, a master cell group (MCG) refers to a group of serving cells associated with the MN, and the MCG includes PCell). A secondary cell group (SCG) refers to a group of serving cells associated with the SN, and the SCG includes a primary cell referred to as the primary secondary cell (PSCell). A special cell (SpCell) refers to the PCell of the MCG or the PSCell of the SCG.

In some deployments, such as deployment 200, operations of the radio access node 202 may be carried out, at least partly, in a central/centralized unit (CU), such as a server, host or node, operationally coupled to a distributed unit (DU), such as a radio head/node. It is also possible that node operations may be distributed among a plurality of servers, hosts or nodes. It should also be understood that the distribution of work between CN 106 operations and radio access node 202 operations may vary depending on implementation.

A 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may include, for example, a radio link control (RLC), medium access control (MAC) layer and a physical (PHY) layer, whereas the gNB-CU (also called a CU) may include the layers above the RLC layer, such as a packet data convergence protocol (PDCP) layer, a radio resource control (RRC), and an internet protocol (IP) layer. Other functional splits are also possible. It is considered that a skilled person is familiar with the open systems interconnection (OSI) model and the functionalities within each layer.

In some example implementations, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU, and the boundary where the responsibility is shifted between the CU and the DU may be selected according to implementation.

Although only one radio access node 202 is shown in FIG. 2, the deployment may comprise multiple radio access nodes, and at least some of the radio access nodes may be connected to one another by a network interface, such as an Xn interface. Similarly, the radio access nodes may be connected to the CN 106 by a network interface. In 5G NR, the network interface between a radio access node and the CN is referred to as the NG interface, which is a network interface between the radio access node and an access and mobility management function (AMF) of the 5GC. These and other network interfaces may support the exchange of signaling messages between network entities. The signaling messages may be formatted according to an application layer protocol, such as the NG application protocol (NGAP) for the NG interface between the radio access node and the CN.

For a UE 110 in an RRC connected state, it is generally desirable to keep the UE's traffic uninterrupted when the UE 110 moves within a cell (at times referred to as a radio cell) or across different cells of one or more radio access nodes 202. To continuously monitor the UE's radio link condition toward a serving cell provided by a serving radio access node, the UE may be configured to measure received signal level and quality from the serving cell as well as a list of configured neighboring cells, and report the results to the radio access node periodically and/or whenever a configured reporting event is met. These measurements may then be evaluated at the radio access node, and may result in a handover (HO) of the UE from the serving cell provided by the serving radio access node (a handover source access node) to a new cell provided by a target radio access node (a target handover access node). The mobility of a UE may also be provided by a so-called conditional handover (CHO) procedure, a lower-layer triggered mobility (LTM) procedure, or the like.

A reporting event (at times referred to as a “measurement reporting event,” or more simply an “event”) is a type of reporting configuration that is linked to a measurement object (measObject) with a measurement identity (measId). The reporting configuration enables a UE 110 to track a reporting event for a specific frequency, as indicated by the measurement object.

A number of measurement reporting events are defined that may be configured to trigger a UE 110 to initiate a measurement reporting. Examples of these measurement reporting events include an event A1 (the serving cell becomes better than threshold), an event A2 (the serving cell becomes worse than threshold), an event A3 (neighboring cell becomes offset better than SpCell), an event A4 (neighboring cell becomes better than threshold), an event A5 (SPCell becomes worse than a first threshold and neighboring cell becomes better than a second threshold), and an event A6 (neighboring cell becomes offset better than SCell).

A reporting event may include an entering condition and a leaving condition. The entering condition may describe one or more criteria that triggers measurement reporting related to the reporting event. The leaving condition on the other hand may describe one or more criteria that determines when the UE 110 stops monitoring and reporting measurements related to the reporting event.

After a neighboring cell triggers an event entering condition, the neighboring cell may be added into an event-specific list and stored by the UE 110 until the neighboring cell triggers an event leave condition for the same event. The list of triggered cells may kept in a UE variable list (cellsTriggeredList) defined within a UE variable (VarMeasReportList) that includes information about the measurements for which the triggering conditions have been met. A cell triggering an event entering condition may also trigger the measurement reporting procedure.

Once reporting is triggered for the same event, the UE 110 may send a measurement report that includes neighboring cell measurements (measResultNeighCells). The UE may include the best neighboring cells up to a maximum number (maxReportCells) of the neighboring cells from cellsTriggeredList in measResultNeighCells. The UE may sort or otherwise order the neighboring cells in decreasing quality of the measurement quantity used to trigger the event, such as reference signal received power (RSRP) or reference signal received quality (RSRQ). This may mean that those of the neighboring cells outside of maxReportCells may be left out of the measurement report, even if those neighboring cells trigger the event. It may also be notable that cellsTriggeredList is measurement object specific as such the list is per carrier that the UE is configured to measure and the UE may store multiple of such lists.

FIG. 3 illustrates a measurement reporting scenario 300 in which a cell that triggers a reporting event A4 is reported. Cell 1 is shown with a straight line, cell 2 is shown with a dashed lined, and cell 3 is shown with a dotted dashed line. The Y axis shows the signal strength of the cells and x axis may show UE position or time. Another straight line shows the A4 offset configured for this event, if the signal strength of a cell is more than the A4 offset (can also be referred to as threshold) then UE triggers a reporting. In this example, only event A4 is illustrated but such an example is valid for any other event type such as A3, A5, A6 etc. as well.

As shown in FIG. 3, assume cell 1 and cell 2 have fulfilled the event entering condition for the reporting event that triggers a measurement report, and that maxReportcells configured as two. The UE 110 will therefore report the two cells that triggered the reporting event. If another cell, cell 3, triggers the reporting event, and if cell 1 and cell 2 are stronger than cell 3, then cell 3 will not be included in the measurement report due to maxReportCells being set to two. The UE may put the cell 3 in cellsTriggeredList, but a measurement result for cell 3 will be left out of the measurement report from the UE. A similar example can be also formulated for the event leave condition in which the cell that triggers event leave may not be reported.

As the ordering happens only during the reporting procedure, the UE 110 may not keep a list of ordered cells, and instead simply send a new measurement report when an entering condition or a leaving condition is fulfilled. Among the maxReportCells that are reported after some time passes, the network may be unsure of the order of the cells. This may create issues for preparation for CHO and LTM, and/or execution for all handovers.

For preparation, for example, the network being unaware of the ordered list of neighboring cells may cause unnecessary reservation for some neighboring cells not being de-configured, and other neighboring cells not being prepared in time.

For execution, the network possibly being unaware of the best cell may cause one or more issues. For conventional handover, the network may not trigger handover to the best cell that fulfilled an event entering condition. As handover may be triggered at the UE 110 for CHO, there may be no execution issue when the network is unaware of the best cell. For LTM, if only layer 3 (L3) measurements are used again, the cell switch may be triggered to the non-best cell. On the other hand, if layer 1 (L1) measurements are used, this may not be an issue.

In view of the foregoing, example implementations of the present disclosure provide a solution whereby measurement quantities of reported neighboring cells, as well as those that have fulfilled a reporting event triggering condition, may be tracked and maintained. The reported neighboring cells and the triggered neighboring cells may be ordered by decreasing measurement quantity, such as signal strength based on a configured reference signal and report quantity. In various examples, the signal strength may be expressed by RSRP or RSRQ, based on a configured reference signal such as channel state information (CSI) or synchronization signal (SS). A change of the reported neighboring cells may itself be a condition of a reporting event, and fulfillment of the reporting event may trigger a measurement reporting.

In some examples, a change of the reported neighboring cells may include a change in an ordered list of the best neighboring cells. In this context, the best neighboring cells may be determined based on highest signal strength, signal quality, signal-to-interference ratio, or other measurement quantity. The best neighboring cells may include the best neighboring cell, second best neighboring cell, third best neighboring cell, up to a number of cells that the UE 110 is configured to report.

In some examples, a change of the reported neighboring cells may include a change in a list of the neighboring cells to be reported. In these examples, the list of neighboring cells to be reported may be determined based on an ordering of the neighboring cells based on measurement quantity, such as signal strength, signal quality or signal-to-interference ratio. A change in these examples may mean a new neighboring cell is added to the list of the neighboring cells to be reported.

Some example implementations therefore provide a UE 110 that may be configured with an indication (e.g., reportOnOrderChange) to monitor for a change of the reported ones of the neighboring cells, or more particularly, the measurement quantities for the reported ones of the neighboring cells.

The UE 110 may perform measurements on neighboring cells to obtain second measurement quantities for the neighboring cells. The UE may determine a change of reported ones of the neighboring cells from a first measurement reporting. The change may include a reordering of the reported ones of the neighboring cells, an addition of a new neighboring cell in the reported ones of the neighboring cells, or the like.

The UE 110 may determine the change of the reported ones of the neighboring cells based on a comparison of the second measurement quantities and first measurement quantities for at least the reported ones of the neighboring cells during the first measurement reporting. In some examples, the first measurement quantities may be the last measurements of neighboring cells. Likewise, in various examples, the second measurement quantities may be measurement quantities at a time of first reporting of a neighboring cell, measurement quantities at a time of first reporting of another cell, or measurement quantities stored in a list of one cell or of another cell.

The UE 110 determining the change of the reported ones of the neighboring cells triggers a second measurement report; and accordingly, the UE may be configured to initiate the second measurement reporting of at least some of the second measurement quantities based on the triggering. In some examples, the change of the reported ones of the neighboring cells is a condition of a reporting event, and fulfillment of the reporting event triggers the second measurement reporting. The UE may therefore make the network aware of the current quality of the neighboring cells for which the network is enabled to configure, de-configure, and re-configure handover (e.g., HO, CHO, LTM), as well as select the best cell(s) for handover. This may also facilitate a reduction in resource reservation, and enable a fast handover without extra time to prepare a cell. The UE may in turn have improved mobility robustness.

The UE 110 may be configured to determine the change of the reported neighboring cells in a number of different manners. In some examples, the UE may first detect a change in the measurement quantity for at least one of the neighboring cells, and may further determine that the change is significant. The UE may then check if the order of the reported neighboring cells has changed. In some of these examples, the UE may keep track of the signal strength or other measurement quantity of a list (e.g., varmeasResult) of logged neighboring cells.

The UE 110 may use a configured threshold value (e.g., a hysteresis value) and a configured threshold time period (e.g., a timetoTrigger) and to detect a change of the measurement quantity. The threshold value and threshold time period may be used to avoid excessive reporting towards the network. In this regard, the UE may use the threshold value and threshold time period to determine if a change in the measurement quantity, and in turn the change of the reported neighboring cells, sufficiently stable to take into account. is stable to take in to account. In particular, for example, the UE may determine that the measurement quantity of at least one neighboring cell has changed by at least the threshold value for at least the threshold time period. The UE may then determine if the order of the reported neighboring cells has changed; and if so, trigger a measurement reporting.

In some of these examples, the UE 110 may therefore determine a change in at least one second measurement quantity relative to at least one first measurement quantity for at least one of the neighboring cells. In some more particular examples, the UE may determine that the second measurement quantity(ies) differs from the first measurement quantity(ies) by at least a configured threshold value or for at least a configured threshold time period.

The UE 110 may determine the change of the reported ones of the neighboring cells based on the change in the second measurement quantity(ies). In some examples, the first measurement quantity(ies) may be obtained from a list (e.g., varmeasResult) in which the neighboring cells and the first measurement quantities for the neighboring cells are set in decreasing order. The UE may update the first measurement quantity(ies) in the list with the second measurement quantity(ies) for which the change is determined, and reorder the list of the neighboring cells according to the first measurement quantities in decreasing order. The UE may then determine that an order of a topmost of a configured number of the neighboring cells in the list differs from a decreasing order of the reported ones of the neighboring cells from the first reporting. In some examples, the decreasing order of the reported ones of the neighboring cells may be obtained from a list (e.g., varCellList) in which the reported ones of the neighboring cells and the first measurement quantities for the reported ones of the neighboring cells are set in a decreasing order.

In other examples, the UE 110 may first check if an order of two or more of the neighboring cells has changed, and then detect significant change in the measurement quantity (e.g., signal strength) of the neighboring cells. In some of these examples, the UE may keep track of the signal strength or other measurement quantity of a list (e.g., varCellList) of reported neighboring cells. In case UE detects the two or more neighboring cells in the list have been re-ordered due to change of measurement quantities, the UE may starts a timer with the expiration value of a configured threshold time period (e.g., a timetoTrigger). If the timer expires and measurement quantities of the two or more neighboring cells that have changed order have changed by more than a configured threshold value (e.g., a hysteresis value), a measurement reporting may be triggered.

In some of these other examples, the UE 110 may therefore determine a change in an order of two or more of the second measurement quantities relative to a corresponding order of two or more of the first measurement quantities for two or more of the neighboring cells. The UE may then determine the change of the reported ones of the neighboring cells based on the change in the order of the two or more of the second measurement quantities. In examples in which the measurement quantities are signal strengths, the UE may determine a change in one of the two or more signal strength values being greater than another one of the two or more of the signal strength values.

In some examples, the two or more of the first measurement quantities are obtained from a list (e.g., varmeasResult, varCellList) of at least the reported ones of the neighboring cells and the first measurement quantities for at least the reported ones of the neighboring cells. In some of these examples, the list may be an ordered list. Also, in some of these examples, the two or more of the first measurement quantities may be adjacent one another in the list.

In some examples, the UE 110 is further configured to make a determination that at least one second measurement quantity of the two or more of the second measurement quantities differs from at least one first measurement quantity of the two or more first measurement quantities by at least a configured threshold value (e.g., hysteresis value) or for at least a configured threshold time period (e.g., timetoTrigger). In other examples, the determination may be that the two or more of the second measurement quantities differ from one another by at least the configured threshold value or for at least the configured threshold time period. The change of the reported ones of the neighboring cells may then be determined further based on the determination.

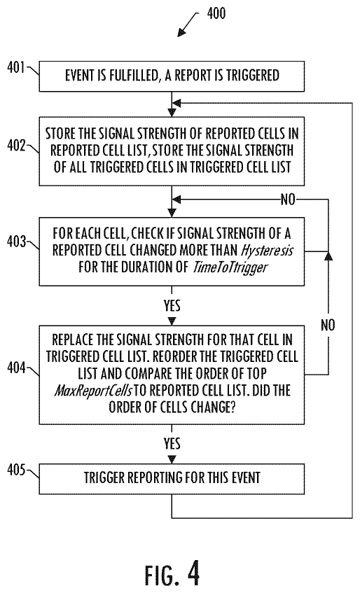

To further illustrate some example implementations of the present disclosure, FIG. 4 is a flow diagram for the UE 110 to track the order of reported neighboring cells. Although not separately shown, the UE may at an initial step receive a measurement configuration that indicates UE to report if the order of the reported cell changes. This indication may be expressed in an information element such as reportOnOrderChange. The UE may also be configured with a hysteresis value and timetoTrigger (also at times referred to as TTT), which in some examples may be reused from another reporting configuration and measurement configuration.

The UE 110 at step 401 determines that an event is fulfilled for a measId, and the UE creates a cellsTriggeredList of neighboring cells for that measId. The UE sends a measurement report including the best maxReportCells from the cellsTriggeredList.

While the measurement report is being sent, the UE at step 402 creates a triggered cell list at report (varmeasResult) in which the UE stores the signal values at the time of reporting for the neighboring cells from cellsTriggeredList, and the UE stores the measId. In other examples, the UE may store the reference signal type (rsType) and report quantity type (reportQuantity) linked to the measId in a separate variable. The UE also at step 402 creates a second reported cell ordered list (varCellList) in which the UE stores the order of the reported best maxReportCells cells. The UE continues performing measurements as configured.

In some examples, after each measurement of signal strengths is performed, the UE at step 403 compares the signal strength for each neighboring cell stored in triggered cell list at report to the measurement of the signal strength. If the measurement of the signal strength has changed (increased or decreased) more than the hysteresis value indicated in the initial step for the duration of timeToTrigger, the UE at step 404 updates the signal strength stored in triggered cell list at report. If the measurement of the signal strength has otherwise not changed more than the hysteresis value during timeToTrigger, the UE continues monitoring the signal strength for the neighboring cell. The UE then continues at steps 403 and 404 for each of the neighboring cells in cellsTriggeredList.

If any signal strength for a neighboring cell cells stored in triggered cell list at report is updated, the UE 110 also at step 404 creates a new list after re-ordering the neighboring cells according to rsType and reportQuantity. The UE then compares the order of the best maxReportCells to the reported cell ordered list; and if the order of the neighboring cells changed in the newly-created list, the UE at step 404 triggers a new measurement report.

In other examples, the UE 110 monitors the signal strength of a neighboring cell compared the next better and next worse neighboring cell in the reported cell ordered list or triggered cell list at report. In some of these other examples, the UE may trigger a new measurement report when the order of the respective neighboring cells changes, and their signal strengths have changed (relative to the earlier measurement reporting or relative to one another) more than the hysteresis value for the duration of timeToTrigger.

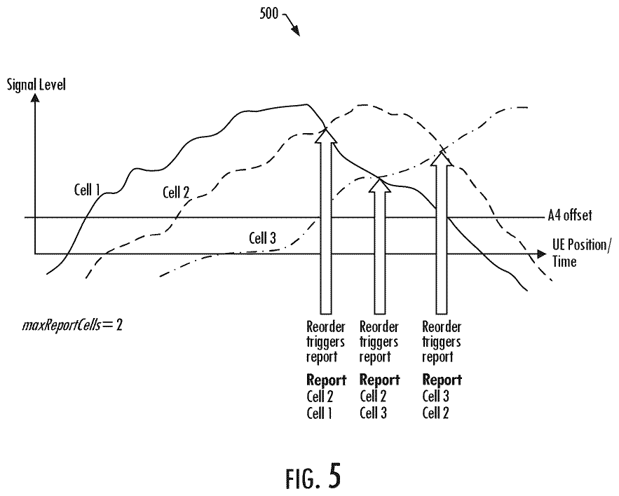

FIG. 5 illustrates a measurement reporting scenario 500, according to some example implementations. As shown, when cell 2 becomes stronger compared to cell 1, the UE 110 may trigger a new measurement report. The UE may track when cell 2 becomes the strongest, and cell 1 becomes the second strongest cell. The change event may not only enable the network to track the strongest cell, but the change event may also enable the UE to track the second strongest cell. In this regard, a new measurement reporting may also be triggered when cell 3 becomes the second strongest cell.

As indicated above, enabling the UE 110 to report the strongest cell may enable the network to prepare the neighboring cell as a candidate cell for CHO and LTM, and may also enable the network to trigger execution of handover towards the strongest cell. Enabling the UE to also report the second, third or other strong cells may also enable the network to prepare those neighboring cells as candidate cells for CHO and LTM to any mobility procedure in time to be ready for the execution when needed.

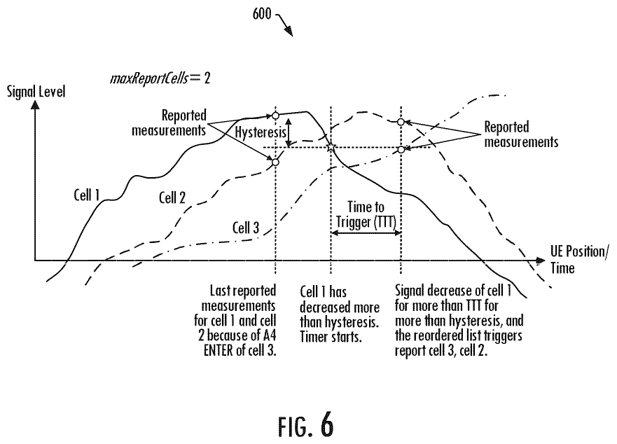

FIG. 5 does not show the hysteresis value and timetoTrigger for the illustrated reporting events. FIG. 6 illustrates a similar measurement reporting scenario 600 including the hysteresis value and timetoTrigger for a reporting event, according to some examples. As shown, from the time of the last measurement report, the UE 110 monitors the neighboring cells. If the measurement of at least one of the neighboring cells has changed more than the hysteresis value during timetoTrigger, then the UE checks the order of the neighboring cells, and triggers a new measurement report if the order has changed.

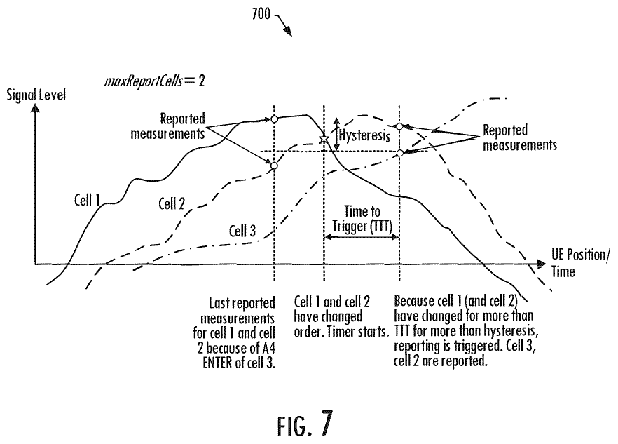

FIG. 7 illustrates another measurement reporting scenario 700 including the hysteresis value and timetoTrigger for a reporting event, according to some other examples. As shown in FIG. 7, the reordering of the measurements for cell 1 and cell 2 triggers a timer for the duration timetoTrigger. The UE monitors the measurements of neighboring cells that are adjacent to each other in the ordered list of neighboring cells at the time of reporting. In case the order of the neighboring cells change due to one cell signal strength increasing relative to the other one, Then, the UE starts to monitor if the signal strength change between these two neighboring cells is higher than the hysteresis for a timetoTrigger, or the UE starts to monitor if the signal strength one or both neighboring cells changed more than the hysteresis for the duration of timeToTrigger. If this happens, the UE triggers a reporting.

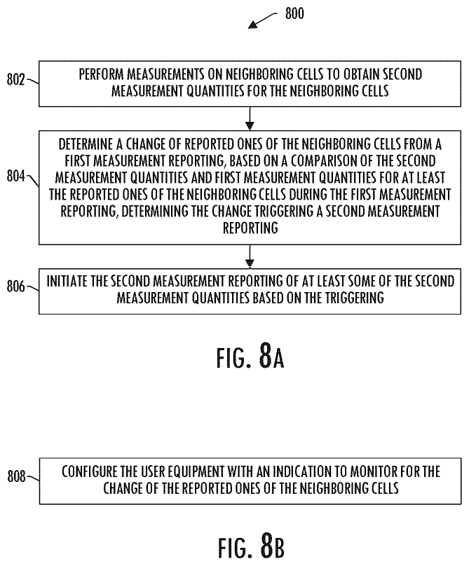

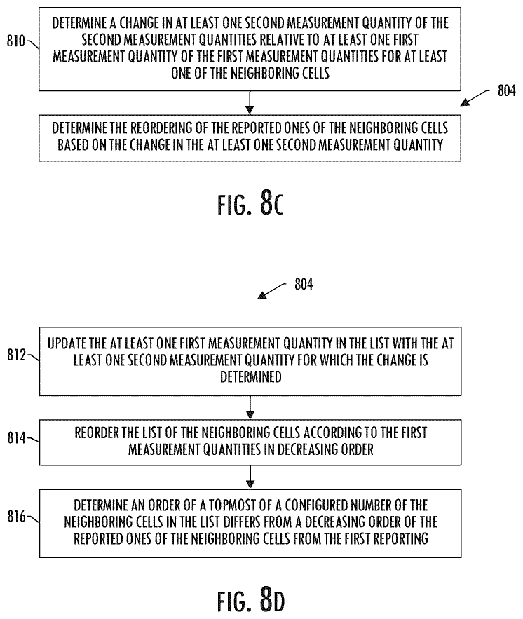

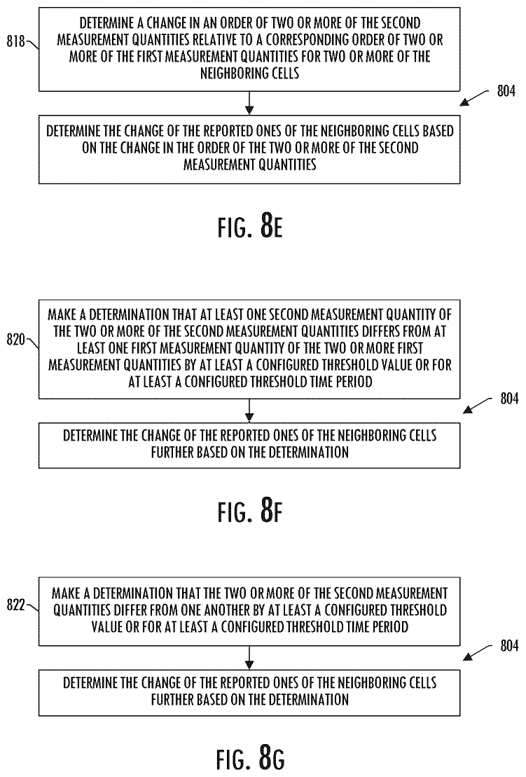

FIGS. 8A-8G are flowcharts illustrating various steps in a method 800 according to various example implementations. The method includes performing measurements on neighboring cells to obtain second measurement quantities for the neighboring cells, as shown at block 802 of FIG. 8A. The method includes determining a change of reported ones of the neighboring cells from a first measurement reporting, based on a comparison of the second measurement quantities and first measurement quantities for at least the reported ones of the neighboring cells during the first measurement reporting, determining the change triggering a second measurement reporting, as shown at block 804. And the method includes initiating the second measurement reporting of at least some of the second measurement quantities based on the triggering, as shown at block 806.

In some examples, the change of the reported ones of the neighboring cells includes a reordering of the reported ones of the neighboring cells.

In some examples, the change of the reported ones of the neighboring cells includes an addition of a new neighboring cell in the reported ones of the neighboring cells.

In some examples, the method 800 is performed by a user equipment, and the method further includes configuring the user equipment with an indication to monitor for the change of the reported ones of the neighboring cells, as shown at block 808 of FIG. 8B.

In some examples, the change of the reported ones of the neighboring cells is a condition of a reporting event, and fulfillment of the reporting event triggers the second measurement reporting.

In some examples, the method 800 further includes determining a change in at least one second measurement quantity of the second measurement quantities relative to at least one first measurement quantity of the first measurement quantities for at least one of the neighboring cells, as shown at block 810 of FIG. 8C. In some of these examples, the change of the reported ones of the neighboring cells is determined at block 804 based on the change in the at least one second measurement quantity.

In some examples, the at least one first measurement quantity is obtained from a list in which the neighboring cells and the first measurement quantities for the neighboring cells are set in decreasing order. In some of these examples, determining the change of the reported ones of the neighboring cells at block 804 includes updating the at least one first measurement quantity in the list with the at least one second measurement quantity for which the change is determined, as shown at block 812 of FIG. 8D. Also in some of these examples, determining the change includes reordering the list of the neighboring cells according to the first measurement quantities in decreasing order, as shown at block 814. And determining the change includes determining an order of a topmost of a configured number of the neighboring cells in the list differs from a decreasing order of the reported ones of the neighboring cells from the first reporting, as shown at block 816.

In some examples, determining the change in the at least one second measurement quantity at block 810 includes determining that the at least one second measurement quantity differs from the at least one first measurement quantity by at least a configured threshold value or for at least a configured threshold time period.

In some examples, the method 800 further includes determining a change in an order of two or more of the second measurement quantities relative to a corresponding order of two or more of the first measurement quantities for two or more of the neighboring cells, as shown at block 818 of FIG. 8E. In some of these examples, the change of the reported ones of the neighboring cells is determined at block 804 based on the change in the order of the two or more of the second measurement quantities.

In some examples, the two or more of the measurement quantities are two or more signal strength values for the two or more of the neighboring cells. In some of these examples, determining the change in the order of the two or more of the second measurement quantities at block 818 includes determining a change in one of the two or more signal strength values being greater than another one of the two or more of the signal strength values.

In some examples, the two or more of the first measurement quantities are obtained from a list of at least the reported ones of the neighboring cells and the first measurement quantities for at least the reported ones of the neighboring cells. In some of these examples, the two or more of the first measurement quantities are adjacent one another in the list.

In some examples, the method 800 further includes making a determination that at least one second measurement quantity of the two or more of the second measurement quantities differs from at least one first measurement quantity of the two or more first measurement quantities by at least a configured threshold value or for at least a configured threshold time period, as shown at block 820 of FIG. 8F. In some of these examples, the change of the reported ones of the neighboring cells is determined at block 804 further based on the determination.

In some examples, the method 800 further includes making a determination that the two or more of the second measurement quantities differ from one another by at least a configured threshold value or for at least a configured threshold time period, as shown at block 822 of FIG. 8G. In some of these examples, the change of the reported ones of the neighboring cells is determined at block 804 further based on the determination.

According to example implementations of the present disclosure, a telecommunications system 100 or PLMN 102, and its components such as a UE 110, CN 106, RAN 108 and/or radio access node 202, may be implemented by various means. Means for implementing the system and its components may include hardware, firmware, software, or combinations thereof. In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

According to some example implementations, at least some of the method 800 described with respect to FIGS. 8A-8G may be carried out by an apparatus comprising means for performing functions corresponding steps of the method. Examples of a suitable apparatus may include a user equipment, user device, user terminal or the like.

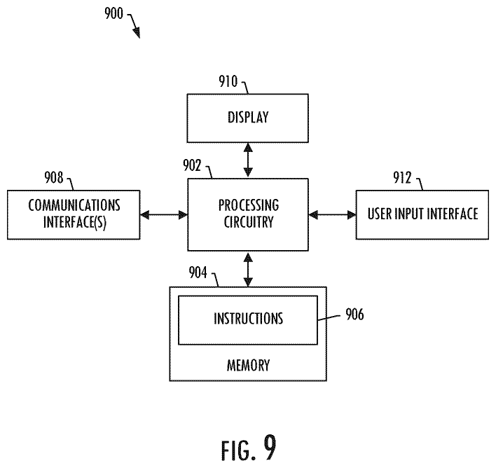

FIG. 9 illustrates an apparatus 900 in which means for performing various functions includes hardware, alone or under direction of one or more computer programs from a computer-readable storage medium or other memory, such as computer memory, according to some example implementations of the present disclosure. Generally, an apparatus of example implementations of the present disclosure may comprise, include or be embodied in one or more fixed or portable electronic devices. Examples of suitable electronic devices include a wearable computer, mobile phone, portable computer, desktop computer, workstation computer, server (server computer) or the like. The apparatus may include one or more of each of a number of components such as, for example, processing circuitry 902 connected to computer-readable storage medium or other memory 904.

The processing circuitry 902 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 904 (of the same or another apparatus).

The processing circuitry 902 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 904 is generally any piece of computer hardware that is capable of storing information such as, for example, data, computer programs, instructions 906 (e.g., computer-readable program code) and/or other suitable information either on a temporary basis and/or a permanent basis. The memory may include volatile and/or non-volatile memory, and may be fixed or removable. Examples of suitable memory include recording media, random access memory (RAM), read-only memory (ROM), a hard drive, a flash memory, a thumb drive, a removable computer diskette, an optical disk or some combination thereof.

The memory 904 is a non-transitory device capable of storing information. One example of a suitable memory is a computer-readable storage medium, which is distinguishable from a computer-readable transmission medium capable of carrying information from one location to another. Examples of suitable computer-readable transmission media comprise electronic carrier signals, telecommunications signals, software distribution packages, or some combination thereof. As used herein, the term “non-transitory” is a limitation of the medium itself (i.e., tangible, not a signal) as opposed to a limitation on data storage persistency (e.g., RAM versus ROM). A computer-readable medium as described herein generally refers to a computer-readable storage medium or computer-readable transmission medium. A computer-readable medium is any entity or device capable in which information, such as one or more computer programs or portions thereof, may be stored and carried.

In addition to the memory 904 (e.g., computer-readable storage medium), the processing circuitry 902 may also be connected to one or more interfaces for displaying, transmitting and/or receiving information. The interfaces may include a communications interface 908 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 910 and/or one or more user input interfaces 912. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

Execution of the instructions 906 by the processing circuitry 902, or storage of the instructions in the memory 904, supports combinations of operations for implementing example implementations of the present disclosure. In this manner, an apparatus 900 may comprise at least one processing circuitry and at least one memory coupled to the at least one processing circuitry, where the at least one processing circuitry is configured to execute instructions stored in the at least one memory. It will also be understood that one or more functions, and combinations of functions, may be implemented by special purpose hardware-based computer systems and/or processing circuitry which perform the specified functions, or combinations of special purpose hardware and program code instructions.

Some example implementations of the present disclosure may also be carried out in the form of a computer process defined by one or more computer programs or portions thereof. Example implementations of the present disclosure may be carried out by executing at least one portion of a computer program comprising instructions. The computer program may be in source code form, object code form, or in some intermediate form. The computer program may be stored in a computer-readable medium that is readable by a computer, processing circuitry or other suitable apparatus. As indicated above, for example, the computer program may be stored in a memory, such as a computer-readable storage medium. Additionally or alternatively, for example, the computer program may be stored in a computer-readable transmission medium. The coding of software for carrying out example implementations of the present disclosure is well within the scope of a person of ordinary skill in the art.

As will be appreciated, any suitable instructions may be loaded onto a computer, a processing circuitry or other programmable apparatus from a memory or a computer-readable medium (e.g., computer-readable storage medium, computer-readable transmission medium) to produce a particular machine, such that the particular machine becomes a means for implementing the functions specified herein. The instructions may also be stored in a computer-readable medium that can direct a computer, a processing circuitry or other programmable apparatus to function in a particular manner to thereby generate a particular machine or particular article of manufacture. In some examples, the instructions stored in the computer-readable medium may produce an article of manufacture, where the article of manufacture becomes a means for implementing functions described herein. The instructions may be retrieved from a computer-readable medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of instructions comprising program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

As explained above and reiterated below, the present disclosure includes, without limitation, the following example implementations.
Clause 1. An apparatus comprising: at least one memory configured to store instructions; and at least one processing circuitry configured to access the at least one memory, and execute the instructions to cause the apparatus to at least: perform measurements on neighboring cells to obtain second measurement quantities for the neighboring cells; determine a change of reported ones of the neighboring cells from a first measurement reporting, based on a comparison of the second measurement quantities and first measurement quantities for at least the reported ones of the neighboring cells during the first measurement reporting, determination of the change triggering a second measurement reporting; and initiate the second measurement reporting of at least some of the second measurement quantities based on the triggering.
Clause 2. The apparatus of clause 1, wherein the change of the reported ones of the neighboring cells includes a reordering of the reported ones of the neighboring cells.
Clause 3. The apparatus of clause 1 or clause 2, wherein the change of the reported ones of the neighboring cells includes an addition of a new neighboring cell in the reported ones of the neighboring cells.
Clause 4. The apparatus of any of clauses 1 to 3, wherein the apparatus is implemented by a user equipment, and the at least one processing circuitry is configured to execute the instructions to cause the apparatus to further configure the user equipment with an indication to monitor for the change of the reported ones of the neighboring cells.
Clause 5. The apparatus of any of clauses 1 to 4, wherein the change of the reported ones of the neighboring cells is a condition of a reporting event, and fulfillment of the reporting event triggers the second measurement reporting.
Clause 6. The apparatus of any of clauses 1 to 5, wherein the at least one processing circuitry is configured to execute the instructions to cause the apparatus to further determine a change in at least one second measurement quantity of the second measurement quantities relative to at least one first measurement quantity of the first measurement quantities for at least one of the neighboring cells, and wherein the change of the reported ones of the neighboring cells is determined based on the change in the at least one second measurement quantity.
Clause 7. The apparatus of clause 6, wherein the at least one first measurement quantity is obtained from a list in which the neighboring cells and the first measurement quantities for the neighboring cells are set in decreasing order, and wherein the apparatus caused to determine the change of the reported ones of the neighboring cells includes the apparatus caused to: update the at least one first measurement quantity in the list with the at least one second measurement quantity for which the change is determined; reorder the list of the neighboring cells according to the first measurement quantities in decreasing order; and determine an order of a topmost of a configured number of the neighboring cells in the list differs from a decreasing order of the reported ones of the neighboring cells from the first reporting.
Clause 8. The apparatus of clause 6 or clause 7, wherein the apparatus caused to determine the change in the at least one second measurement quantity includes the apparatus caused to determine that the at least one second measurement quantity differs from the at least one first measurement quantity by at least a configured threshold value or for at least a configured threshold time period.
Clause 9. The apparatus of any of clauses 1 to 8, wherein the at least one processing circuitry is configured to execute the instructions to cause the apparatus to further determine a change in an order of two or more of the second measurement quantities relative to a corresponding order of two or more of the first measurement quantities for two or more of the neighboring cells, and wherein the change of the reported ones of the neighboring cells is determined based on the change in the order of the two or more of the second measurement quantities.
Clause 10. The apparatus of clause 9, wherein the two or more of the measurement quantities are two or more signal strength values for the two or more of the neighboring cells, and wherein the apparatus caused to determine the change in the order of the two or more of the second measurement quantities includes the apparatus caused to determine a change in one of the two or more signal strength values being greater than another one of the two or more of the signal strength values.
Clause 11. The apparatus of clause 9 or clause 10, wherein the two or more of the first measurement quantities are obtained from a list of at least the reported ones of the neighboring cells and the first measurement quantities for at least the reported ones of the neighboring cells, and wherein the two or more of the first measurement quantities are adjacent one another in the list.
Clause 12. The apparatus of any of clauses 9 to 11, wherein the at least one processing circuitry is configured to execute the instructions to cause the apparatus to further make a determination that at least one second measurement quantity of the two or more of the second measurement quantities differs from at least one first measurement quantity of the two or more first measurement quantities by at least a configured threshold value or for at least a configured threshold time period, and wherein the change of the reported ones of the neighboring cells is determined further based on the determination.
Clause 13. The apparatus of any of clauses 9 to 12, wherein the at least one processing circuitry is configured to execute the instructions to cause the apparatus to further make a determination that the two or more of the second measurement quantities differ from one another by at least a configured threshold value or for at least a configured threshold time period, and wherein the change of the reported ones of the neighboring cells is determined further based on the determination.
Clause 14. An apparatus comprising: means for performing measurements on neighboring cells to obtain second measurement quantities for the neighboring cells; means for determining a change of reported ones of the neighboring cells from a first measurement reporting, based on a comparison of the second measurement quantities and first measurement quantities for at least the reported ones of the neighboring cells during the first measurement reporting, determining the change triggering a second measurement reporting; and means for initiating the second measurement reporting of at least some of the second measurement quantities based on the triggering.
Clause 15. The apparatus of clause 14, wherein the change of the reported ones of the neighboring cells includes a reordering of the reported ones of the neighboring cells.
Clause 16. The apparatus of clause 14 or clause 15, wherein the change of the reported ones of the neighboring cells includes an addition of a new neighboring cell in the reported ones of the neighboring cells.
Clause 17. The apparatus of any of clauses 14 to 16, wherein the apparatus is implemented by a user equipment, and the apparatus further comprises means for configuring the user equipment with an indication to monitor for the change of the reported ones of the neighboring cells.
Clause 18. The apparatus of any of clauses 14 to 17, wherein the change of the reported ones of the neighboring cells is a condition of a reporting event, and fulfillment of the reporting event triggers the second measurement reporting.
Clause 19. The apparatus of any of clauses 14 to 18, wherein the apparatus further comprises means for determining a change in at least one second measurement quantity of the second measurement quantities relative to at least one first measurement quantity of the first measurement quantities for at least one of the neighboring cells, and wherein the change of the reported ones of the neighboring cells is determined based on the change in the at least one second measurement quantity.
Clause 20. The apparatus of clause 19, wherein the at least one first measurement quantity is obtained from a list in which the neighboring cells and the first measurement quantities for the neighboring cells are set in decreasing order, and wherein the means for determining the change of the reported ones of the neighboring cells comprises: means for updating the at least one first measurement quantity in the list with the at least one second measurement quantity for which the change is determined; means for reordering the list of the neighboring cells according to the first measurement quantities in decreasing order; and means for determining an order of a topmost of a configured number of the neighboring cells in the list differs from a decreasing order of the reported ones of the neighboring cells from the first reporting.
Clause 21. The apparatus of clause 19 or clause 20, wherein the means for determining the change in the at least one second measurement quantity comprises means for determining that the at least one second measurement quantity differs from the at least one first measurement quantity by at least a configured threshold value or for at least a configured threshold time period.
Clause 22. The apparatus of any of clauses 14 to 21, wherein the apparatus further comprises means for determining a change in an order of two or more of the second measurement quantities relative to a corresponding order of two or more of the first measurement quantities for two or more of the neighboring cells, and wherein the change of the reported ones of the neighboring cells is determined based on the change in the order of the two or more of the second measurement quantities.
Clause 23. The apparatus of clause 22, wherein the two or more of the measurement quantities are two or more signal strength values for the two or more of the neighboring cells, and wherein the means for determining the change in the order of the two or more of the second measurement quantities comprises means for determining a change in one of the two or more signal strength values being greater than another one of the two or more of the signal strength values.
Clause 24. The apparatus of clause 22 or clause 23, wherein the two or more of the first measurement quantities are obtained from a list of at least the reported ones of the neighboring cells and the first measurement quantities for at least the reported ones of the neighboring cells, and wherein the two or more of the first measurement quantities are adjacent one another in the list.
Clause 25. The apparatus of any of clauses 22 to 24, wherein the apparatus further comprises means for making a determination that at least one second measurement quantity of the two or more of the second measurement quantities differs from at least one first measurement quantity of the two or more first measurement quantities by at least a configured threshold value or for at least a configured threshold time period, and wherein the change of the reported ones of the neighboring cells is determined further based on the determination.
Clause 26. The apparatus of any of clauses 22 to 25, wherein the apparatus further comprises means for making a determination that the two or more of the second measurement quantities differ from one another by at least a configured threshold value or for at least a configured threshold time period, and wherein the change of the reported ones of the neighboring cells is determined further based on the determination.
Clause 27. A method comprising: performing measurements on neighboring cells to obtain second measurement quantities for the neighboring cells; determining a change of reported ones of the neighboring cells from a first measurement reporting, based on a comparison of the second measurement quantities and first measurement quantities for at least the reported ones of the neighboring cells during the first measurement reporting, determining the change triggering a second measurement reporting; and initiating the second measurement reporting of at least some of the second measurement quantities based on the triggering.
Clause 28. The method of clause 27, wherein the change of the reported ones of the neighboring cells includes a reordering of the reported ones of the neighboring cells.
Clause 29. The method of clause 27 or clause 28, wherein the change of the reported ones of the neighboring cells includes an addition of a new neighboring cell in the reported ones of the neighboring cells.
Clause 30. The method of any of clauses 27 to 29, wherein the method is performed by a user equipment, and the method further comprises configuring the user equipment with an indication to monitor for the change of the reported ones of the neighboring cells.
Clause 31. The method of any of clauses 27 to 30, wherein the change of the reported ones of the neighboring cells is a condition of a reporting event, and fulfillment of the reporting event triggers the second measurement reporting.
Clause 32. The method of any of clauses 27 to 31, wherein the method further comprises determining a change in at least one second measurement quantity of the second measurement quantities relative to at least one first measurement quantity of the first measurement quantities for at least one of the neighboring cells, and wherein the change of the reported ones of the neighboring cells is determined based on the change in the at least one second measurement quantity.
Clause 33. The method of clause 32, wherein the at least one first measurement quantity is obtained from a list in which the neighboring cells and the first measurement quantities for the neighboring cells are set in decreasing order, and wherein determining the change of the reported ones of the neighboring cells comprises: updating the at least one first measurement quantity in the list with the at least one second measurement quantity for which the change is determined; reordering the list of the neighboring cells according to the first measurement quantities in decreasing order; and determining an order of a topmost of a configured number of the neighboring cells in the list differs from a decreasing order of the reported ones of the neighboring cells from the first reporting.
Clause 34. The method of clause 32 or clause 33, wherein determining the change in the at least one second measurement quantity comprises determining that the at least one second measurement quantity differs from the at least one first measurement quantity by at least a configured threshold value or for at least a configured threshold time period.
Clause 35. The method of any of clauses 27 to 34, wherein the method further comprises determining a change in an order of two or more of the second measurement quantities relative to a corresponding order of two or more of the first measurement quantities for two or more of the neighboring cells, and wherein the change of the reported ones of the neighboring cells is determined based on the change in the order of the two or more of the second measurement quantities.
Clause 36. The method of clause 35, wherein the two or more of the measurement quantities are two or more signal strength values for the two or more of the neighboring cells, and wherein determining the change in the order of the two or more of the second measurement quantities comprises determining a change in one of the two or more signal strength values being greater than another one of the two or more of the signal strength values.
Clause 37. The method of clause 35 or clause 36, wherein the two or more of the first measurement quantities are obtained from a list of at least the reported ones of the neighboring cells and the first measurement quantities for at least the reported ones of the neighboring cells, and wherein the two or more of the first measurement quantities are adjacent one another in the list.
Clause 38. The method of any of clauses 35 to 37, wherein the method further comprises making a determination that at least one second measurement quantity of the two or more of the second measurement quantities differs from at least one first measurement quantity of the two or more first measurement quantities by at least a configured threshold value or for at least a configured threshold time period, and wherein the change of the reported ones of the neighboring cells is determined further based on the determination.
Clause 39. The method of any of clauses 35 to 38, wherein the method further comprises making a determination that the two or more of the second measurement quantities differ from one another by at least a configured threshold value or for at least a configured threshold time period, and wherein the change of the reported ones of the neighboring cells is determined further based on the determination.
Clause 40. A computer-readable storage medium that is non-transitory and has instructions stored therein that, in response to execution by at least one processing circuitry, causes an apparatus to at least: perform measurements on neighboring cells to obtain second measurement quantities for the neighboring cells; determine a change of reported ones of the neighboring cells from a first measurement reporting, based on a comparison of the second measurement quantities and first measurement quantities for at least the reported ones of the neighboring cells during the first measurement reporting, determination of the change triggering a second measurement reporting; and initiate the second measurement reporting of at least some of the second measurement quantities based on the triggering.
Clause 41. The computer-readable storage medium of clause 40, wherein the change of the reported ones of the neighboring cells includes a reordering of the reported ones of the neighboring cells.
Clause 42. The computer-readable storage medium of clause 40 or clause 41, wherein the change of the reported ones of the neighboring cells includes an addition of a new neighboring cell in the reported ones of the neighboring cells.
Clause 43. The computer-readable storage medium of any of clauses 40 to 42, wherein the method is performed by a user equipment, and the computer-readable storage medium has further instructions stored therein that, in response to execution by the at least one processing circuitry, causes the apparatus to further configure the user equipment with an indication to monitor for the change of the reported ones of the neighboring cells.
Clause 44. The computer-readable storage medium of any of clauses 40 to 43, wherein the change of the reported ones of the neighboring cells is a condition of a reporting event, and fulfillment of the reporting event triggers the second measurement reporting,
Clause 45. The computer-readable storage medium of any of clauses 40 to 44, wherein the computer-readable storage medium has further instructions stored therein that, in response to execution by the at least one processing circuitry, causes the apparatus to further determine a change in at least one second measurement quantity of the second measurement quantities relative to at least one first measurement quantity of the first measurement quantities for at least one of the neighboring cells, and wherein the change of the reported ones of the neighboring cells is determined based on the change in the at least one second measurement quantity.
Clause 46. The computer-readable storage medium of clause 45, wherein the at least one first measurement quantity is obtained from a list in which the neighboring cells and the first measurement quantities for the neighboring cells are set in decreasing order, and wherein the apparatus caused to determine the change of the reported ones of the neighboring cells includes the apparatus caused to: update the at least one first measurement quantity in the list with the at least one second measurement quantity for which the change is determined; reorder the list of the neighboring cells according to the first measurement quantities in decreasing order; and determine an order of a topmost of a configured number of the neighboring cells in the list differs from a decreasing order of the reported ones of the neighboring cells from the first reporting.
Clause 47. The computer-readable storage medium of clause 45 or clause 46, wherein the apparatus caused to determine the change in the at least one second measurement quantity includes the apparatus caused to determine that the at least one second measurement quantity differs from the at least one first measurement quantity by at least a configured threshold value or for at least a configured threshold time period.
Clause 48. The computer-readable storage medium of any of clauses 40 to 47, wherein the computer-readable storage medium has further instructions stored therein that, in response to execution by the at least one processing circuitry, causes the apparatus to further determine a change in an order of two or more of the second measurement quantities relative to a corresponding order of two or more of the first measurement quantities for two or more of the neighboring cells, and wherein the change of the reported ones of the neighboring cells is determined based on the change in the order of the two or more of the second measurement quantities.
Clause 49. The computer-readable storage medium of clause 48, wherein the two or more of the measurement quantities are two or more signal strength values for the two or more of the neighboring cells, and wherein the apparatus caused to determine the change in the order of the two or more of the second measurement quantities includes the apparatus caused to determine a change in one of the two or more signal strength values being greater than another one of the two or more of the signal strength values.
Clause 50. The computer-readable storage medium of clause 48 or clause 49, wherein the two or more of the first measurement quantities are obtained from a list of at least the reported ones of the neighboring cells and the first measurement quantities for at least the reported ones of the neighboring cells, and wherein the two or more of the first measurement quantities are adjacent one another in the list.
Clause 51. The computer-readable storage medium of any of clauses 48 to 50, wherein the computer-readable storage medium has further instructions stored therein that, in response to execution by the at least one processing circuitry, causes the apparatus to further make a determination that at least one second measurement quantity of the two or more of the second measurement quantities differs from at least one first measurement quantity of the two or more first measurement quantities by at least a configured threshold value or for at least a configured threshold time period, and wherein the change of the reported ones of the neighboring cells is determined further based on the determination.
Clause 52. The computer-readable storage medium of any of clauses 48 to 51, wherein the computer-readable storage medium has further instructions stored therein that, in response to execution by the at least one processing circuitry, causes the apparatus to further make a determination that the two or more of the second measurement quantities differ from one another by at least a configured threshold value or for at least a configured threshold time period, and wherein the change of the reported ones of the neighboring cells is determined further based on the determination.
Clause 53. An apparatus comprising means for performing the method of any of clauses 27 to 39.
Clause 54. A computer-readable medium comprising instructions that, in response to execution by at least one processing circuitry, causes an apparatus to perform the method of any of clauses 27 to 39.
Clause 55. A computer-readable storage medium comprising instructions that, in response to execution by at least one processing circuitry, causes an apparatus to perform the method of any of clauses 27 to 39.
Clause 56. A computer program comprising instructions that, in response to execution by at least one processing circuitry, causes an apparatus to perform the method of any of clauses 27 to 39.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory storing instructions that, when executed by the at least one processor, cause the apparatus at least to:
perform measurements on neighboring cells to obtain second measurement quantities for the neighboring cells;
determine a change of reported ones of the neighboring cells from a first measurement reporting, based on a comparison of the second measurement quantities and first measurement quantities for at least the reported ones of the neighboring cells during the first measurement reporting, determining the change triggering a second measurement reporting; and
initiate the second measurement reporting of at least some of the second measurement quantities based on the triggering.

2. The apparatus of claim 1, wherein the change of the reported ones of the neighboring cells includes a reordering of the reported ones of the neighboring cells.

3. The apparatus of claim 1, wherein the change of the reported ones of the neighboring cells includes an addition of a new neighboring cell in the reported ones of the neighboring cells.

4. The apparatus of claim 1, wherein the apparatus is implemented by a user equipment, and the apparatus is further caused to configure the user equipment with an indication to monitor for the change of the reported ones of the neighboring cells.

5. The apparatus of claim 1, wherein the change of the reported ones of the neighboring cells is a condition of a reporting event, and fulfillment of the reporting event triggers the second measurement reporting.

6. The apparatus of claim 1, wherein the apparatus is further caused to determine a change in at least one second measurement quantity of the second measurement quantities relative to at least one first measurement quantity of the first measurement quantities for at least one of the neighboring cells, and
wherein the change of the reported ones of the neighboring cells is determined based on the change in the at least one second measurement quantity.

7. The apparatus of claim 6, wherein the at least one first measurement quantity is obtained from a list in which the neighboring cells and the first measurement quantities for the neighboring cells are set in decreasing order, and wherein the determining the change of the reported ones of the neighboring cells comprises:
updating the at least one first measurement quantity in the list with the at least one second measurement quantity for which the change is determined;
reordering the list of the neighboring cells according to the first measurement quantities in decreasing order; and
determining an order of a topmost of a configured number of the neighboring cells in the list differs from a decreasing order of the reported ones of the neighboring cells from the first reporting.

8. The apparatus of claim 6, wherein determining the change in the at least one second measurement quantity comprises determining that the at least one second measurement quantity differs from the at least one first measurement quantity by at least a configured threshold value or for at least a configured threshold time period.

9. The apparatus of claim 1, wherein the apparatus is further caused to determine a change in an order of two or more of the second measurement quantities relative to a corresponding order of two or more of the first measurement quantities for two or more of the neighboring cells, and
wherein the change of the reported ones of the neighboring cells is determined based on the change in the order of the two or more of the second measurement quantities.

10. The apparatus of claim 9, wherein the two or more of the measurement quantities are two or more signal strength values for the two or more of the neighboring cells, and
wherein the apparatus is caused to determine the change in the order of the two or more of the second measurement quantities by determining a change in one of the two or more signal strength values being greater than another one of the two or more of the signal strength values.

11. The apparatus of claim 9, wherein the two or more of the first measurement quantities are obtained from a list of at least the reported ones of the neighboring cells and the first measurement quantities for at least the reported ones of the neighboring cells, and
wherein the two or more of the first measurement quantities are adjacent one another in the list.

12. The apparatus of claim 9, wherein the apparatus is further caused to make a determination that at least one second measurement quantity of the two or more of the second measurement quantities differs from at least one first measurement quantity of the two or more first measurement quantities by at least a configured threshold value or for at least a configured threshold time period, and
wherein the change of the reported ones of the neighboring cells is determined further based on the determination.

13. The apparatus of claim 9, wherein the apparatus is further caused to make a determination that the two or more of the second measurement quantities differ from one another by at least a configured threshold value or for at least a configured threshold time period, and
wherein the change of the reported ones of the neighboring cells is determined further based on the determination.

14. A method comprising:
performing measurements on neighboring cells to obtain second measurement quantities for the neighboring cells;
determining a change of reported ones of the neighboring cells from a first measurement reporting, based on a comparison of the second measurement quantities and first measurement quantities for at least the reported ones of the neighboring cells during the first measurement reporting, determining the change triggering a second measurement reporting; and
initiating the second measurement reporting of at least some of the second measurement quantities based on the triggering.

15. The method of claim 14, wherein the change of the reported ones of the neighboring cells includes a reordering of the reported ones of the neighboring cells.

16. The method of claim 14, wherein the change of the reported ones of the neighboring cells includes an addition of a new neighboring cell in the reported ones of the neighboring cells.

17. The method of claim 14, wherein the method is performed by a user equipment, and the method further comprises configuring the user equipment with an indication to monitor for the change of the reported ones of the neighboring cells.

18. The method of claim 14, wherein the change of the reported ones of the neighboring cells is a condition of a reporting event, and fulfillment of the reporting event triggers the second measurement reporting.

19. The method of claim 14, wherein the method further comprises determining a change in at least one second measurement quantity of the second measurement quantities relative to at least one first measurement quantity of the first measurement quantities for at least one of the neighboring cells, and
wherein the change of the reported ones of the neighboring cells is determined based on the change in the at least one second measurement quantity.

20. The method of claim 19, wherein the at least one first measurement quantity is obtained from a list in which the neighboring cells and the first measurement quantities for the neighboring cells are set in decreasing order, and wherein determining the change of the reported ones of the neighboring cells comprises:
updating the at least one first measurement quantity in the list with the at least one second measurement quantity for which the change is determined;
reordering the list of the neighboring cells according to the first measurement quantities in decreasing order; and
determining an order of a topmost of a configured number of the neighboring cells in the list differs from a decreasing order of the reported ones of the neighboring cells from the first reporting.

21. The method of claim 19, wherein determining the change in the at least one second measurement quantity comprises determining that the at least one second measurement quantity differs from the at least one first measurement quantity by at least a configured threshold value or for at least a configured threshold time period.

22. The method of claim 14, wherein the method further comprises determining a change in an order of two or more of the second measurement quantities relative to a corresponding order of two or more of the first measurement quantities for two or more of the neighboring cells, and
wherein the change of the reported ones of the neighboring cells is determined based on the change in the order of the two or more of the second measurement quantities.

23. The method of claim 22, wherein the two or more of the measurement quantities are two or more signal strength values for the two or more of the neighboring cells, and
wherein determining the change in the order of the two or more of the second measurement quantities comprises determining a change in one of the two or more signal strength values being greater than another one of the two or more of the signal strength values.

24. The method of claim 22, wherein the two or more of the first measurement quantities are obtained from a list of at least the reported ones of the neighboring cells and the first measurement quantities for at least the reported ones of the neighboring cells, and
wherein the two or more of the first measurement quantities are adjacent one another in the list.

25. The method of claim 22, wherein the method further comprises making a determination that at least one second measurement quantity of the two or more of the second measurement quantities differs from at least one first measurement quantity of the two or more first measurement quantities by at least a configured threshold value or for at least a configured threshold time period, and
wherein the change of the reported ones of the neighboring cells is determined further based on the determination.

26. The method of claim 22, wherein the method further comprises making a determination that the two or more of the second measurement quantities differ from one another by at least a configured threshold value or for at least a configured threshold time period, and
wherein the change of the reported ones of the neighboring cells is determined further based on the determination.
